(19) United States
(12) Patent Application Publication
(10) Pub. No.: US 2007/0210289 A1
(43) Pub. Date: Sep. 13, 2007

(54) Powered drive for jack

(76) Inventor: Frank Drake, Wausau, WI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/700,671

(22) Filed: Jan. 31, 2007

Related U.S. Application Data
(60) Provisional application No. 60/763,703, filed on Jan. 31, 2006.

(51) Int. Cl. B66F 3/18

(52) U.S. Cl. 254/103; 74/89.23

(57) ABSTRACT

A motorized gearbox having a drive shaft is provided. The motorized gearbox provides input power to rotate the drive shaft. The drive shaft is inserted into a jack housing. Rotation of the drive shaft raises or lowers the jack housing. The integrated drive shaft is capable of replacing a hand crank and an input shaft of a mechanically operated jack to convert the mechanically operated jack to a motorized jack.

### CROSS-REFERENCE TO RELATED APPLICATION

This application claims priority from U.S. Provisional Patent Application No. 60/763,703, filed on Jan. 31, 2006, and titled POWERED DRIVE FOR JACK, which is hereby incorporated in its entirety by reference.

### FIELD OF ART

This invention relates generally to mechanical jacks, and more particularly, to a powered drive for a mechanical jack.

### BACKGROUND OF THE INVENTION

Many mechanical jacks used in the automotive and trailer industries are operated by hand. Thus, the application of human strength is required to rotate the jack handle to raise and lower the jack. However, there are numerous instances where it is inconvenient, difficult, or impossible to operate the jack by hand. Therefore, there are numerous occasions where motorized operation of the jack is desired. In addition, a motorized jack is especially desirable in the retail sector, such as, through the modification of an existing manual jack with a replacement, after-market, powered drive component.

In addition, mechanical cranking and a great amount of physical exertion is required in order to quickly provide a significant amount of jack elongation or contraction of the jack. Accordingly, it is often desirable to incorporate a drop leg to eliminate or at least reduce mechanical cranking required in order to provide significant elongation or contraction in a short amount of time, such as at the beginning or completion of the lifting process.

As is known in the art, when an after-market modification is made to a jack to include an after-market motor, the motor is mounted to the jack so that the original driving shaft of the jack is aligned with the gearbox of the motor. Such a modification requires coupling the motor to the jack and to the jack shaft. However, any misalignment of the motor and the shaft or the motor and the jack can result in the misapplication of torque to the jack shaft. Frequently, misalignment causes excessive wear of parts, the loss of power from the motor, or damage to the motor and components of the jack.

It would be advantageous to resolve such alignment issues in the after-market applications so that the problems associated with misalignment are eliminated. Further, an assembled motorized jack is desirable, especially in the retail market. As such, providing an integral motor and shaft either originally or in an after-market replacement component obviates alignment issues problematic in the industry.

### SUMMARY OF INVENTION

The present invention provides a powered drive for a jack. The powered drive comprises a motorized gearbox having an integral drive shaft for attachment to the jack. The motorized gearbox provides input power to rotate the drive shaft and, in turn, to raise or lower an outer tube of the jack. A cover is provided for enclosing the powered drive to prevent damage to the powered drive. The jack has a torque stop that is positionable between the cover and the outer jack tube to dampen vibrations from the motor.

### BRIEF DESCRIPTION OF THE DRAWINGS

The drawings illustrate the best mode presently contemplated for carrying out the invention. In the drawings:

FIG. 1 illustrates a jack having a motorized gearbox in an embodiment of the present invention;

FIG. 2 a is a magnified and interior view of the relevant portion of the jack of FIG. 1;

FIG. 3 is a chart showing current draw versus load for the present invention as compared to competitive products by Equalizer and Lunde.

### DETAILED DESCRIPTION OF THE INVENTION

It should be clear that the invention described herein could be utilized with any type of jack (e.g. with or without drop legs, one or more gear ratios, etc.). Nevertheless, the embodiment described herein is described with reference to the after-market modification of a single-speed jack to replace the actuator and drive shaft with an integral powered drive and drive shaft. The jack of the present invention may, however, be manufactured with the integral powered drive and drive shaft.

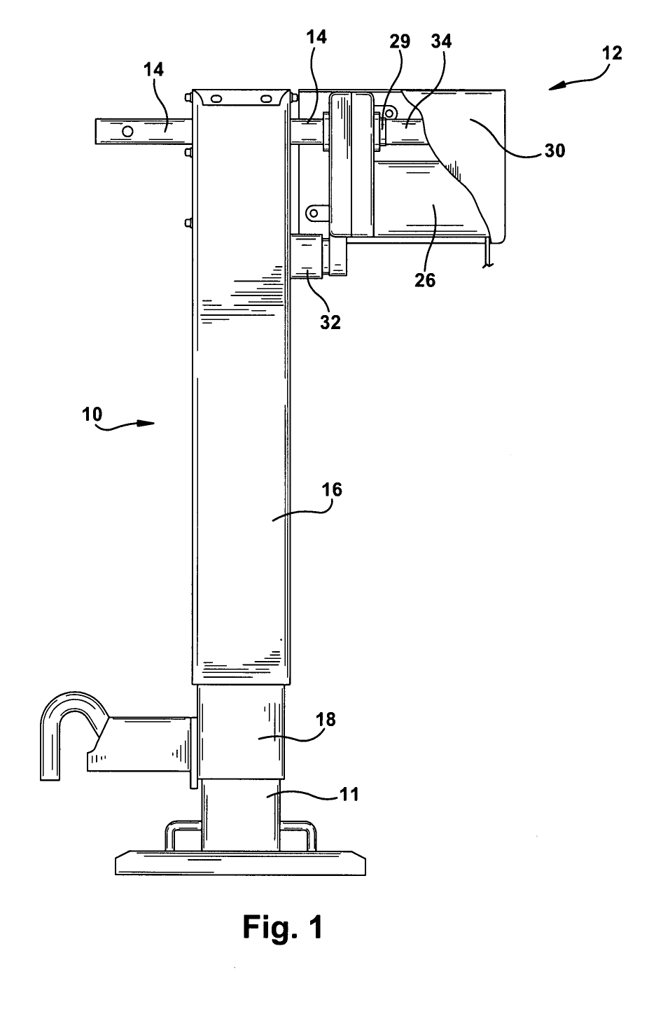

Referring to FIG. 1, a jack 10, in the embodiment shown, is generally a single-speed mechanical jack incorporating a drop leg 11 or “through the air” leg. The drop leg 11 can be used, for example, to quickly lower the drop leg 11 to the ground. The jack 10 can be used with any object that needs to be raised or lowered, including but not limited to, horse trailers, livestock trailers, large flatbed trailers, and construction equipment trailers. The jack 10 has been modified according to an embodiment of the invention so as to replace the input shaft and handle of a manually operated jack with the powered drive 12 and integral drive shaft 14. Alternatively, the jack 10 may be manufactured with the powered drive 12 and the integral drive shaft 14.

The jack 10 has an outer jack tube 16 telescopically movable with respect to an inner jack tube 18. The drop leg 11 telescopically moves with respect to the jack tubes 16, 18 from a raised position to a lowered position. At the lowered position, the drop leg 11 extends from the inner jack tube 18 to contact, for example, the ground. In an embodiment, the drop leg 11 telescopically moves into the inner jack tube 18 to the raised position. The powered drive 12 rotates the drive shaft 14 to raise the outer jack tube 16 with respect to the inner jack tube 18.

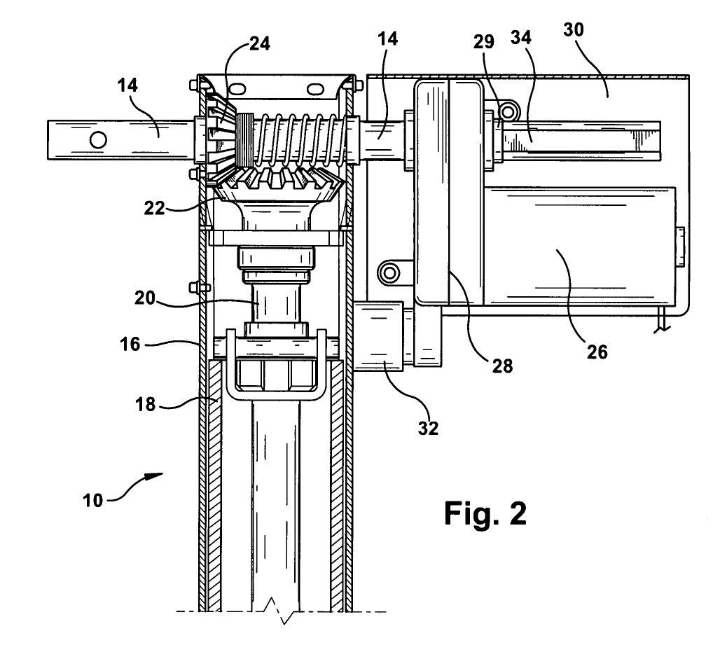

As best shown in FIG. 2, the jack 10 includes the outer jack tube 16 and the inner jack tube 18 driven by a rotating drive screw 20. The drive screw 20 is coupled to driven gear 22 that engages a drive gear 24 so as to receive input torque. In a preferred embodiment, the driven gear 22 and the drive gear 24 are bevel gears that meshingly engage to drive the drive screw 20.

Torque input from the drive shaft 14 rotates the drive gear 24 and engages the driven gear 22. In an embodiment as shown in FIG. 2, the horizontal rotation of the drive shaft 14 is translated into vertical movement of the inner jack tube 18. The drive screw 20 is coupled to the driven gear 22 to translate torque into telescopic movement of the inner jack tube 18.

A motor 26 inputs power into a gearbox 28. In a preferred embodiment, the motor 26 is an electric motor. Power from the motor 26 is transmitted through the gearbox 28 to the drive shaft 14 so as to rotate the drive shaft 14. In a preferred embodiment, the motor 26 and the gearbox 28 are an integrated motorized gearbox. As such, when connecting the integral drive shaft 14 and powered drive 12 to a previously manually operated jack, no secondary coupling and alignment issues are created. As described above, attempting to connect an external motor and gearbox to the original jack drive shaft as is presently performed in the industry creates such coupling and alignment issues.

The drive shaft 14 is integrally formed with the gearbox 28. The drive shaft 14 extends from the gearbox 28 through the outer jack tube 16. The drive gear 24 connects to the drive shaft 14 such that rotation of the drive shaft 14 imparts rotation of the drive gear 24. The gearbox 28 rotates the drive shaft 14 by, for example, frictionally gripping the drive shaft 14. In a preferred embodiment, the drive shaft 14 has a hex end 34 that engages a female hex output 29 of the gearbox 28.

The motor 26 and the gearbox 28 have a cover 30 to, for example, prevent damage and debris from damaging the powered drive 12. The cover 30 may be a two-sided protective cover for the powered drive 12. In an embodiment, the cover 30 is secured to the outer jack tube 16 to house the motor 26 and the gearbox 28.

When modifying a manually actuated jack to be equipped with the powered drive 12, the handle and drive shaft of the manually actuated jack are removed. The integral drive shaft 14 of the powered drive 12 is inserted into the jack 10. For example, the integral drive shaft 14 is inserted through a side of the outer jack tube 16 through the drive gear 24 and out an opposing side of the outer jack tube 16. The powered drive 12 can then be mounted to the jack 10 according to known methods in the industry.

As shown in FIG. 2, the powered drive 12 has a torque stop 32 that is mounted between the upper jack tube 16 and the powered drive 12 so as to absorb motor start-up and stall energy. In a preferred embodiment, the torque stop 32 is made of a vibration damping material. For example, the torque stop may be a rubber stop to absorb start-up and stall energy from the motor 26. The torque stop 32 may be positioned on the outer tube 16 and adjacent to the cover 30.

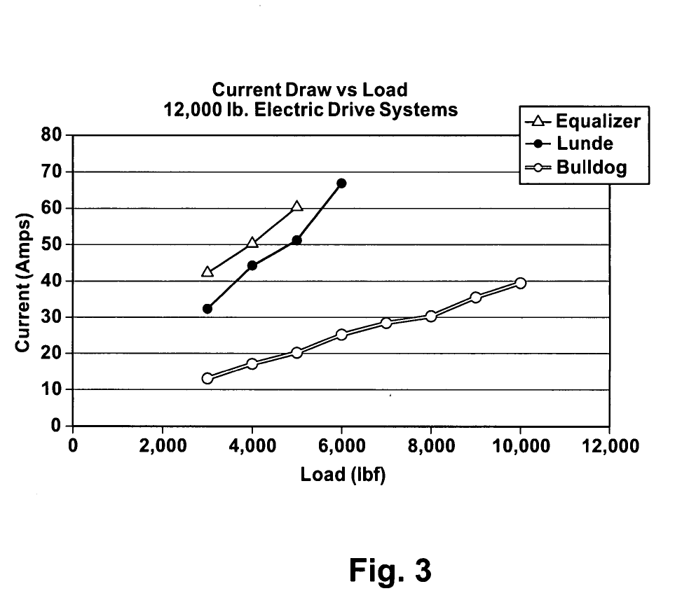

Further, current modifications to manually operated jacks comprise large gearboxes and motors that can be cumbersome to install and require significant space. As shown in the embodiment of the invention of FIG. 2, the gearbox 28 is sized to fit within the profile of the jack 10 to preserve space and assist in the installation of the powered drive 12. In addition, the powered drive 12 as disclosed herein provides more torque, greater lifting capacity, and does so at about half the current draw as other competitive products, as shown in FIG. 3.

In anticipation of using the powered jack for a dual jack application, the interior end of the drive shaft 14 has a hex end 34 that is connectable to an extension pipe and/or a second drive shaft (not shown). The extension pipe may have a hex cavity at one end that slides over the hex end 34 of the drive shaft 14 and is coupled to a drive shaft of the second jack at the other end. As a result, the present invention allows for easy coupling to a second jack without use of pins or bolts. In addition, coupling to a second jack does not require an exact length of pipe, the hex shaft is self-fixturing. The gearbox 28 may then drive the second drive shaft to raise or lower a second jack tube.

In an embodiment of the present invention, a kit may be provided for converting a manually operated jack to a powered drive jack of the present invention. The kit may comprise the powered drive 12 having the integral drive shaft 14. In addition, the kit may have the cover 30 and the torque stop 32. To convert a manually operated jack to a powered drive jack of the present invention, an input shaft and a handle of a manually operated jack are removed. The gearbox 28 having the integral drive shaft 14 is inserted into the outer jack tube 16 and through the drive gear 24. The drive shaft 24 may be inserted through an opposing side of the outer jack tube 16. The gearbox 28 may then be secured to the jack 10.

The kit may have an extension pipe that is attachable to the hex end 34 of the drive shaft 14. The extension pipe is connectable to an input shaft (or drive shaft) of a second jack for raising or lowering a jack tube of the second jack. The torque stop 32 may be positioned on the outer jack tube 16. In an embodiment, the torque stop 32 is attached to the gearbox 28. The cover 30 may be secured such that the torque stop 32 is located between the outer jack tube 16 and the cover 30.

Exemplary embodiments of the present invention have been described above and illustrated in the figures. Modifications and alternations will occur to others upon a reading and understanding of this specification. The claims as follow are intended to include all modifications and alterations insofar as they come within the scope of the claims or the equivalent thereof.

What is claimed is:

1. A powered jack, the powered jack comprising:
a jack housing;
a drive shaft extending from the housing; and
a motorized gearbox secured to the drive shaft; the motorized gearbox providing input power to the drive shaft translating into vertical movement of the jack housing.

2. The powered jack of claim 1 wherein the drive shaft is integrally formed with the motorized gearbox.

3. The powered jack of claim 2 further comprising:
a drive gear coupled to the drive shaft within the jack housing.

4. The powered jack of claim 2 further comprising:
a driven screw engaging the drive gear, the driven screw translating rotational movement of the drive gear into vertical movement of the jack.

5. The powered jack of claim 2 wherein the drive shaft extends through the housing and into the motorized gearbox.

6. The powered jack of claim 2 wherein the motorized gearbox fits within a profile of the jack housing.

7. The powered jack of claim 2 further comprising:
a cover secured to the jack housing, the cover capable of protecting the motorized gearbox.

8. The powered jack of claim 2 further comprising:
a drop leg telescopically movable with respect to the jack housing.

9. The powered jack of claim 2 wherein the motorized gearbox comprises an electric motor integrated with a gearbox.

10. The powered jack of claim 9 wherein the drive shaft has a hex end engaging the motorized gearbox.

11. The powered jack of claim 10 wherein the motorized gearbox has a female hex output for engaging the hex end of the drive shaft.

12. The powered jack of claim 10 wherein the hex end of the drive shaft is connectable to a second drive shaft for raising or lowering a second jack.

13. A kit for converting a mechanically operated jack to a powered jack, the kit comprising:
a gearbox;
a motor coupled to the gearbox, the motor providing input power to the gearbox; and
a drive shaft integrally formed with the gearbox, wherein the drive shaft is capable of insertion into a jack housing of a manually operated jack.

14. The kit of claim 13 wherein the input shaft is integrated with the gearbox.

15. The kit of claim 14 wherein the gearbox and the motor are integrated into a motorized gearbox.

16. The kit of claim 13 further comprising:
a torque stop attachable to the gearbox for dampening vibration from the motor.

17. The kit of claim 16 further comprising:
a cover securable to the jack for housing the motorized gearbox.

18. The kit of claim 13 wherein the shaft has a hex end for engaging the gearbox.

19. The kit of claim 19 wherein the gearbox has a female hex output for engaging the hex end of the gearbox.

20. A method of converting a manually operated jack to a motorized jack, the method comprising the steps of:
removing a handle and input shaft from a manually operated jack housing;
inserting a drive shaft integrated with a motorized gearbox into the jack housing, the drive shaft inserted through the jack housing, wherein the motorized gearbox rotates the drive shaft to impart vertical movement of the jack housing; and
securing the motorized gearbox to the jack housing.
